(19) United States
(12) Patent Application Publication
(10) Pub. No.: US 2023/0079167 A1
(43) Pub. Date: Mar. 16, 2023

(54) METHOD OF PRODUCING HOLLOW FIBER MEMBRANE

(71) Applicant: ASAHI KASEI KABUSHIKI KAISHA, Tokyo (JP)

(72) Inventors: Norihito TANAKA, Tokyo (JP); Tatsuhiro IWAMA, Tokyo (JP); Hirokazu FUJIMURA, Tokyo (JP); Mie NAYUKI, Tokyo (JP)

(73) Assignee: ASAHI KASEI KABUSHIKI KAISHA, Tokyo (JP)

(21) Appl. No.: 18/054,609

(22) Filed: Nov. 11, 2022

Related U.S. Application Data
(62) Division of application No. 16/978,186, filed on Sep. 4, 2020.

(30) Foreign Application Priority Data
Mar. 7, 2018 (JP) 2018-040740

(51) Int. Cl. B01D 69/08; B01D 67/00; B01D 71/34; B01D 71/52

(52) U.S. Cl. CPC B01D 69/08; B01D 67/0002; B01D 71/34; B01D 71/52; B01D 2325/34

(57) ABSTRACT

A method of producing a hollow fiber membrane is provided. The method includes: extruding from a molding nozzle a membrane-forming stock solution, the membrane-forming stock solution containing a vinylidene fluoride-based resin, polyethylene glycol, and a common solvent, and having a slope (B) of 1.15 or more and less than 3.00 where the slope (B) is calculated by I=A×q^{-B} from a scattering intensity of a small-angle X-ray; and solidifying the extruded membrane-forming stock solution in a solution containing water as a main component.

### CROSS-REFERENCE TO RELATED APPLICATION

The present application is a divisional application of U.S. patent application Ser. No. 16/978,186 filed Sep. 4, 2020, which is a National Stage Application of PCT/JP2019/007847 filed Feb. 28, 2019, which claims priority and benefit of Japanese Patent Application No. 2018-040740 filed Mar. 7, 2018. The disclosures of the prior applications are hereby incorporated by reference herein in their entirety.

### TECHNICAL FIELD

This disclosure relates to a hollow fiber membrane used for various water treatment fields such as water purification treatment and seawater clarification, and a method of producing a hollow fiber membrane.

### BACKGROUND

Membrane separation technology has been widely used in various industrial fields such as production of sterile water, high purity water, or drinking water and clarification of seawater. With recent advancements in membrane separation technology, its applications are expanding into other fields such as secondary or tertiary treatment in sewage treatment plants for, e.g., domestic wastewater and industrial wastewater, and highly turbid water treatment, e.g., solid-liquid separation in septic tanks.

As a filter material used for such membrane separation, there are a hollow fiber membrane in which a polymer excellent in processability is formed in a hollow tube shape, a flat membrane in which a polymer is formed in a sheet form, and the like, and a membrane module formed by assembling these membranes is used.

Among these, in particular, porous hollow fiber membranes used for clarifying river water and seawater are required to have high rejection performance, high water permeability for treating a large amount of water, and durability that allows long-term stable operation under pressure fluctuation conditions.

Also, since external pressure filtration is adopted from the viewpoint of increasing the filtration area, it is necessary to provide proper compressive strength for preventing the hollow fiber membrane from being crushed by compression from the outside during filtration operation.

In membrane separation, in general, as fouling substances adhere to the membrane surface on the side to which raw water is supplied with the passage of filtration time, the filtration resistance increases and the filtration efficiency decreases.

Therefore, attempts have been made to improve the fouling resistance and suppress the increase in filtration resistance by subjecting the membrane surface to hydrophilic treatment. This method has the advantages that the membrane formation is relatively easy, and productivity and economy are excellent.

In JP5781140B (PTL 1) and PCT/JP2017/021919 (PTL 2), it is proposed to improve the hydrophilicity of the membrane surface and improving the fouling resistance by adding polyethylene glycol (PEG) which is a hydrophilic polymer to a membrane-forming stock solution used for obtaining a porous hollow fiber membrane comprising a hydrophobic polymer (PVDF-based resin) such that PEG is allowed to remain after the membrane formation.

However, although this method is excellent for hydrophilizing the membrane surface, it is difficult to achieve both high rejection performance and high water permeability at the same time.

### CITATION LIST

### Patent Literature

PTL 1: JP5781140B
PTL 2: PCT/JP2017/021919

### SUMMARY

It would thus be helpful to provide a hollow fiber membrane having both high rejection performance and high water permeability while maintaining good fouling resistance, and a method of producing a hollow fiber membrane.

The inventors conducted extensive studies to solve the aforementioned problem, and as a result completed the present disclosure. Specifically, the present disclosure is as follows.

[1] A hollow fiber membrane comprising a vinylidene fluoride-based resin and polyethylene glycol, wherein the polyethylene glycol has a content of 1.0 part by weight or more and less than 5.0 parts by weight with respect to 100 parts by weight of the vinylidene fluoride-based resin, and in a case where the hollow fiber membrane is divided in three equal parts by a line drawn from an inner surface side to an outer surface side of the hollow fiber membrane in a radial direction of a cross section perpendicular to a longitudinal direction of the hollow fiber membrane, and where polyethylene glycol normalized intensities at respective intermediate points are defined as inner surface part a, central part b, and outer surface part c, c is less than 0.3 and a is 0.5 or more.

[2] The hollow fiber membrane according to [1], wherein a, b, and c satisfy a>b>c.

[3] The hollow fiber membrane according to [1] or [2], wherein b is (a−0.05) or less.

[4] A method of producing a hollow fiber membrane, comprising: extruding from a molding nozzle a membrane-forming stock solution, the membrane-forming stock solution containing a vinylidene fluoride-based resin, polyethylene glycol, and a common solvent, and having a slope (B) of 1.15 or more and less than 3.00 where the slope (B) is calculated by I=A×q^{-B} from a scattering intensity of a small-angle X-ray; and solidifying the extruded membrane-forming stock solution in a solution containing water as a main component.

[5] The method of producing a hollow fiber membrane according to [4], wherein the membrane-forming stock solution has a viscosity of 0.0148 Pa·s or more and less than 0.0200 Pa·s at a shear rate of 50 (l/s) when diluted 10 times with a common solvent.

According to the present disclosure, it is possible to provide a hollow fiber membrane having both high rejection performance and high water permeability while maintaining good fouling resistance, and a method of producing a hollow fiber membrane.

### BRIEF DESCRIPTION OF THE DRAWING

FIG. 1 is a schematic diagram conceptually illustrating a structure of a filtration module for performing a fouling resistance test.

### DETAILED DESCRIPTION

The following provides a detailed description of an embodiment of this disclosure (hereinafter, referred to as the “present embodiment”). However, the present disclosure is not limited to the following embodiment and may be implemented with various alterations that are within the essential scope thereof.

The hollow fiber membrane disclosed herein contains a vinylidene fluoride-based resin as a constituent component. The term “vinylidene fluoride-based resin” means that it contains a homopolymer of vinylidene fluoride and/or a vinylidene fluoride copolymer. A vinylidene fluoride copolymer is a polymer having a vinylidene fluoride residue structure and is typically a copolymer of a vinylidene fluoride monomer and another fluorine-based monomer or the like, and those known in the art may be suitably selected and used. A plurality of vinylidene fluoride copolymers may also be contained.

From the viewpoint of superior strength, a vinylidene fluoride-based resin is preferably a homopolymer, and when it is a copolymer, it is preferable from the same viewpoint to contain vinylidene fluoride in a molar ratio of 50% or more.

The weight-average molecular weight (Mw) of the vinylidene fluoride-based resin is not particularly limited, yet it is preferably 100,000 or more and 1,000,000 or less, and more preferably 200,000 or more and 600,000 or less. Further, the molecular weight distribution is not limited to a single-peak vinylidene fluoride-based resin, and may be a mixture of a plurality of vinylidene fluoride-based resins having different molecular weights.

Besides vinylidene fluoride-based resins, examples of resin components of a hollow fiber membrane used in the water treatment field include hydrophobic polymers such as polysulfone, polyethersulfone, and polyethylene. However, in applications using external pressure filtration and requiring treatment of a large amount of water for clarification of river water or seawater, a vinylidene fluoride-based resin is most preferable from the viewpoint of the membrane strength.

In addition, the hollow fiber membrane disclosed herein contains polyethylene glycol. Preferably, the polyethylene glycol is contained in an amount of 1.0 part by weight or more and less than 5.0 parts by weight with respect to 100 parts by weight of the vinylidene fluoride-based resin. The content is more preferably 2.0 parts by weight or more and less than 4.5 parts by weight.

When the hollow fiber membrane contains hydrophilic polyethylene glycol, the hydrophilicity of the membrane surface is increased and a water molecule layer is easily formed on the membrane surface when the membrane is brought into contact with the aqueous solution. It is thus expected that a water molecule layer is formed on the membrane surface, making it difficult for fouling substances to adhere to the membrane surface and reducing the frequency of contact between the vinylidene fluoride-based resin constituting the membrane and the chemicals used for membrane cleaning, and as a result, the durability of the hollow fiber membrane can be improved.

Here, when the weight-average molecular weight (Mw) of polyethylene glycol is less than 20,000, elution from the membrane tends to increase. On the other hand, when the weight-average molecular weight (Mw) of polyethylene glycol exceeds 300,000, a portion in which polyethylene glycol is contained in a spherical form is generated in the porous body forming the hollow fiber membrane, and the strength of the porous body tends to decrease. On the other hand, if the content of polyethylene glycol is less than 1.0 part by weight, a water molecule layer tends to be difficult to form, and if the content exceeds 5.0 parts by weight, polyethylene glycol excessively attracts water molecules, causing swelling of the membrane, and the amount of permeated water tends to decrease.

Besides polyethylene glycol, examples of the hydrophilic polymer used for hydrophilizing the hydrophobic polymer include polyvinyl pyrrolidone, polyvinyl alcohol, cellulose, and derivatives thereof, yet polyethylene glycol is most preferable in consideration of its properties such as environmental loads, economic efficiency, and persistence to the membrane.

From the viewpoint of increasing the filtration area, the hollow fiber membrane disclosed herein is mainly used in external pressure filtration. Accordingly, it is necessary that the strength in the external pressure direction, i.e., the compressive strength against crushing of the hollow fiber membrane during filtration operation is 0.40 MPa or more. When the compressive strength is 0.40 MPa or more, the hollow fiber membrane can maintain its shape for a long period of time in water treatment applications where operating pressure is applied for a long period of time.

Further, the hollow fiber membrane disclosed herein comprises a hollow portion having an inner diameter of preferably 0.10 mm or more and less than 5.0 mm and an outer diameter of preferably 0.15 mm or more and less than 6.0 mm. If the inner diameter is less than 0.1 mm, pressure loss increases and stable operation can not be guaranteed, and if the outer diameter is 6.0 mm or more, it is difficult to provide a proper filtration area.

Further, the hollow fiber membrane disclosed herein has, when pure water at 25° C. is permeated therethrough at a filtration pressure of 0.1 MPa, a pure water permeability per unit membrane area of preferably 1,000 (L/m²/hr) or more based on the inner surface of the hollow fiber membrane. Pure water used for this is distilled water or water filtered with an ultrafiltration membrane or a reverse osmosis membrane having a molecular cutoff of 10,000 or less.

When the pure water permeability is low, the number of membrane modules required to complete a certain amount of tasks within a given period increases, and the space occupied by the filtration equipment increases. In order to avoid this, it is possible to complete treating a certain amount of water within a given period by setting the filtration pressure high. In this case, however, high pressure resistance is required for the membrane module, the energy cost for filtration is also increased and the productivity is deteriorated.

From the above viewpoints, higher pure water permeability is desirable, and the pure water permeability is preferably 1,500 (L/m²/hr) or more, and more preferably 1,750 (L/m²/hr) or more.

In addition, the hollow fiber membrane preferably has a membrane structure in which trunks of polymer components form a network and pores are provided, in other words, a porous membrane structure in which trunks of polymer components of hollow fibers are three-dimensionally crosslinked in a network-like manner and pores are provided between the trunks of polymer components.

In addition, since the hollow fiber membrane disclosed herein is applied to clarification of river water, seawater, and the like, and it is required to remove MS2 virus (20 nm), the rejection rate of dextran with a weight-average molecular weight of 2,000,000 is preferably 20% or more, and more preferably 40% or more.

The rejection performance of a porous hollow fiber membrane used in external pressure filtration depends on the pore size on the outer surface side in contact with the raw water. Therefore, in order to improve the water permeability performance while maintaining the aforementioned rejection performance, it is conceivable to reduce the membrane thickness or to increase the pore diameter on the inner surface side with respect to the outer surface side to improve the discharge performance.

However, in the former case the reduction of the membrane thickness leads to a decrease in the compressive strength, while in the latter the increase in the pore size on the inner surface side causes a decrease in the specific surface area, making the hydrophilization insufficient for providing good water permeability and fouling resistance.

In a case where the hollow fiber membrane disclosed herein is divided in three equal parts by a line drawn from an inner surface side to an outer surface side of the hollow fiber membrane in a radial direction of a cross section perpendicular to a longitudinal direction of the hollow fiber membrane, and where polyethylene glycol normalized intensities at respective intermediate points are defined as inner surface part a, central part b, and outer surface part c, c is less than 0.3 and a is 0.5 or more. It is noted that the polyethylene glycol normalized intensities at respective intermediate points can be calculated using the method described in the EXAMPLES section below. It is also preferable that a>b>c. In particular, in a configuration with an inclined structure where the pore diameter is increased on the inner surface side relative to the outer surface side, hydrophilicity is given and good water permeability and fouling resistance can be obtained by increasing the polyethylene glycol normalized intensities following the inclination. Also, b is preferably (a−0.05) or less, and more preferably (a−0.08) or less.

In the present disclosure, by having a structure with such a polyethylene glycol distribution, it is possible to achieve both high rejection performance and high water permeability while maintaining good fouling resistance.

When c on the outer surface side in contact with the raw water is 0.3 or more, polyethylene glycol tends to block pores and lower the water permeability on the contrary rather than hydrophilizing the membrane surface. When a on the inner surface side is less than 0.5, a water molecule layer necessary for providing good water permeability and fouling resistance is not formed. Further, from the viewpoint of permeated water discharging performance, b, which is intermediate between a and c, preferably takes a value between a and c, and more preferably takes a value of (a−0.05) or less.

Next, a method of producing a hollow fiber membrane according to the present embodiment will be described.

In the hollow fiber membrane disclosed herein, a so-called wet membrane forming method in which a membrane-forming stock solution containing at least a vinylidene fluoride-based resin, polyethylene glycol, and a common solvent thereof is discharged from the molding nozzle and solidified in a solution containing water as a main component, or a so-called dry/wet membrane forming method in which a predetermined air gap is provided after the discharging from the molding nozzle.

It is preferable that the vinylidene fluoride-based resin used for the membrane-forming stock solution contains a heterogeneous sequence at a certain ratio since a membrane excellent in chemical resistance can be obtained. As used herein, the term “heterogeneous sequence” refers to a portion where PVDF “CF₂” sequences are adjacent to each other and bonded together, which portion is abnormal in that PVDF sequences “CF₂” and “CH₂” would normally be alternately and regularly bonded to each other in a normal (or standard) molecular chain. The proportion of such heterogeneous sequences can be obtained from ¹⁹F-NMR measurement. For example, in the case of PVDF (polyvinylidene fluoride) resin, it is preferable to use one in which the proportion of heterogeneous sequences in the molecule in the ¹⁹F-NMR measurement is 8.0% or more and less than 30.0%. When the proportion of heterogeneous sequences is low, that is, in the case of a PVDF resin having high regularity of PVDF molecular chain sequences, deterioration from cleaning chemicals tends to be accelerated. When the proportion of heterogeneous sequences is high, that is, in the case of a PVDF resin having a low regularity of PVDF molecular chain sequences, the crystallinity which is a feature of the PVDF resin decreases, and a low-intensity porous membrane tends to form.

The proportion of heterogeneous sequences of a PVDF resin can be measured as follows. In a NMR (nuclear magnetic resonance) apparatus, ¹⁹F-NMR measurement of the porous membrane is carried out using d₆-DMF as a solvent and CFCl₃ as an internal standard (0 ppm). From an integral (Ir) of a signal derived from a normal sequence appearing around −92 to −97 ppm in the obtained spectrum and an integral (Ii) of a signal derived from a heterogeneous sequence appearing around −114 to −117 ppm, the proportion of heterogeneous sequences is calculated from the following Formula (1):

proportion of heterogeneous sequences (%)={Ii/(Ir+Ii)×100

The mixing ratio of a hydrophobic polymer such as a vinylidene fluoride-based resin and a hydrophilic polymer such as polyethylene glycol in the membrane-forming stock solution is not particularly limited, yet it is preferably of 20 wt % or more and 40 wt % or less of the hydrophobic polymer component and 8 wt % or more and 30 wt % or less of the hydrophilic polymer component, with the balance being the solvent, and more preferably of 23 wt % or more and 35 wt % or less of the hydrophobic polymer component and 10 wt % or more and 25 wt % or less of the hydrophilic polymer component, with the balance being the solvent.

By forming a membrane using a membrane-forming stock solution within this range, the residual amount of the hydrophilic polymer component can be easily adjusted to a predetermined amount, and it becomes easy to obtain a hollow fiber membrane having high strength and excellent chemical resistance and water permeability.

The common solvent is not particularly limited as long as it can dissolve a hydrophobic polymer such as a vinylidene fluoride-based resin and a hydrophilic polymer such as polyethylene glycol, and those known in the art may be suitably selected and used.

From the viewpoint of improving the stability of the membrane-forming stock solution, as the common solvent, it is preferable to use at least one solvent selected from the group consisting of N-methylpyrrolidone (NMP), dimethylformamide (DMF), dimethylacetamide (DMAC), and dimethylsulfoxide (DMSO). From the viewpoint of easy handling and higher water permeability, N-methylpyrrolidone is particularly preferable.

Also, a mixed solvent of at least one common solvent selected from the above group and another solvent may be used. In this case, it is preferable to use a mixed solvent containing the common solvent selected from the above group such that the total amount of the common solvent is preferably 80% by mass or more, and more preferably 90% by mass or more, based on the total amount of the mixed solvent. The other solvent refers to a solvent capable of dissolving either a hydrophobic polymer such as a vinylidene fluoride-based resin or a hydrophilic polymer such as polyethylene glycol.

The membrane-forming stock solution is prepared by mixing, for example, a vinylidene fluoride-based resin, polyethylene glycol, and a common solvent thereof, and stirring and dissolving them.

As a dissolving method, various dissolving apparatus can be used, including, but not limited to, a general anchor blade stirring mixer, a planetary mixer using a planetary motion of two frame type blades, a Henschel mixer of lower shaft stirring type, a cavitron using a shearing effect of a high-speed rotation rotor, and a kneader of a mixing rotor.

The membrane-forming stock solution disclosed herein has a slope (B) of 1.15 or more and less than 3.00 where the slope (B) is calculated by I=A×q^{-B} from a scattering intensity of a small-angle X-ray within the range of 0.2<q<0.3. The slope is more preferably 1.15 or more and less than 2.00.

It is considered that this slope is correlated with the aggregate size of the vinylidene fluoride-based resin that determines the solution structure of the membrane-forming stock solution. The aggregate size is expected to increase as this slope becomes smaller, and it is considered that the residual amount of polyethylene glycol after the membrane formation will differ since the amount of entanglement with the polyethylene glycol molecular chain varies depending on the aggregate size.

It is considered that if the slope is less than 1.15, the aggregate size is so large that polyethylene glycol tends to easily come off in phase separation, and if the slope is 3.00 or more, the aggregate size is so small that sufficient entanglement is not formed.

The aggregate size of the vinylidene fluoride-based resin that determines the solution structure of the membrane-forming stock solution can be controlled by the order of dissolution. For example, in a case where a polymer having better solubility than the vinylidene fluoride-based resin is first dissolved in a solvent and the vinylidene fluoride-based resin is then compatibly dissolved in the solvent, the molecular chains of the vinylidene fluoride-based resin in the membrane-forming stock solution are difficult to spread due to the influence of the macromolecule, and aggregates of a comparatively small size form. In contrast, when the vinylidene fluoride-based resin is first dissolved in the solvent, the molecular chains of the vinylidene fluoride-based resin easily spread, aggregates of a relatively large size form, and a membrane-forming stock solution having a different solution structure can be obtained.

In addition, the viscosity at a shear rate of 50 (l/s) when the membrane-forming stock solution disclosed herein is diluted with 10 w/w times with a common solvent can be an index indirectly indicating the above-described solution structure. This viscosity is preferably 0.0148 Pa·s or more and less than 0.0200 Pa·s, and more preferably 0.0148 Pa·s or more and less than 0.0180 Pa·s.

A viscosity within this range is considered to form a solution structure in which a hydrophobic polymer such as a vinylidene fluoride-based resin and a hydrophilic polymer such as polyethylene glycol are properly entangled.

As a method for hollow shape molding, it is preferable to use a double-tubular nozzle as a molding nozzle, discharge the membrane-forming stock solution from the double-tubular nozzle together with bore liquid, and solidify them in a solution containing water as a main component. This method is simple and has excellent hollow fiber membrane productivity. As the double-tubular molding nozzle and the bore liquid, those commonly used in the art may be used without particular limitation.

The membrane-forming stock solution discharged from the double-tubular molding nozzle passes through an air gap and reaches a solidifying bath in which a solution containing water as a main component is spread. As used herein, the traveling time for the membrane-forming stock solution discharged from the molding nozzle to land on the solidifying bath surface is referred to as “time in air gap”. The time in air gap is preferably 0.1 second or more and less than 10 seconds. It is more preferably 0.2 seconds or more and less than 5 seconds. When the time in air gap is 0.1 seconds or more, the inner surface can be sufficiently solidified before the membrane-forming stock solution enters the solidifying bath, and even when sudden force is applied from the outer surface side, the membrane can be prevented from flattening upon landing on the bath surface. In addition, when the time in air gap is less than 10 seconds, the membrane can be prevented from stretching and tearing during free travel periods.

Further, in order to form a hollow portion, the bore liquid is poured into the innermost annular ring of the double-tube forming nozzle. The bore liquid is preferably an aqueous solution composed of a common solvent of the membrane-forming stock solution and water, and the concentration of the common solvent in the aqueous solution is preferably 25 wt % or more and 95 wt % or less.

By using such an aqueous solution, the pore diameter on the inner surface side of the porous hollow fiber membrane can be controlled. If the concentration of the common solvent is 25 wt % or more, the pore diameter on the inner surface side can be made larger than that on the outer surface side, and high water permeability can be obtained. In contrast, if the concentration of the common solvent is more than 95 wt %, solidification on the inner surface side is slow, making spinning stability extremely poor.

The residence time of the membrane-forming stock solution in the solidifying bath (in the aqueous solution) is preferably 5.0 seconds or more. When the residence time is set to 5.0 seconds or more, it is possible to guarantee the time necessary for the common solvent of the membrane-forming stock solution existing in a region ranging from the middle of the membrane thickness to the inner surface to diffuse to the non-solvent in the aqueous solution, and to be exchanged. Accordingly, solidification is accelerated and phase separation is stopped in a moderate state. Consequently, the interconnectivity of the membrane structure of the cross section is improved. It is noted that the temperature of the solidifying bath is preferably 45° C. or higher and 95° C. or lower, and more preferably 50° C. or higher and 90° C. or lower. If the temperature of the solidifying bath is raised, the diffusion of the common solvent in the membrane-forming stock solution to the aqueous solution is promoted, and thus the residence time can be shortened.

In addition, a container for controlling temperature and humidity may be provided in the air gap. Regarding this container, no particular limitations are placed on the shape and the like, yet it may have, for example, a prismatic shape or a columnar shape, or it may or may not be sealed.

The temperature environment of the air gap is preferably 3° C. or higher and 90° C. or lower. Within this range, stable temperature control is possible and spinnability can be maintained. The temperature environment is more preferably 5° C. or higher and 85° C. or lower. Also, the relative humidity is in the range of 20% to 100%.

After the membrane formation, heat treatment may be carried out as necessary. The temperature of the heat treatment is preferably 50° C. or higher and lower than 100° C., and more preferably 50° C. or higher and lower than 95° C. Within this temperature range, the coefficient of variation of the outer diameter due to shrinkage of the membrane is suppressed, and the heat treatment can be performed without greatly reducing the amount of permeated water.

As described above, the production methods according to the present disclosure may provide a hollow fiber membrane having both high rejection performance and high water permeability while maintaining good fouling resistance that could not be achieved with the conventional hollow fiber membranes.

### EXAMPLES

Hereinafter, the present disclosure will be described with reference to examples and comparative examples, yet the present disclosure is not so limited.

In each example, a membrane-forming stock solution is first prepared, and then a porous hollow fiber membrane is produced for evaluation of membrane physical properties. In each example, measurement methods were as follows. Unless otherwise noted, measurement is carried out at 25° C.

(1) Slope calculated by fitting of the equation of I=A×q^{-B} SAXS measurement was carried out using the following apparatus and conditions.
Apparatus: NANOPIX manufactured by Rigaku Corporation
X-ray wavelength λ: 0.154 nm
Optical system: Point collimation (1^{st} slit: 0.55 mm φ, 2^{nd} slit: open, guard slit: 0.35 mm φ)
Beamstop: 2 mm φ
Detector: HyPix
Camera length: 1312 mm
Exposure time: 15 min
Measurement temperature: 80° C.

After performing the SAXS measurement on the membrane-forming stock solution, empty cell scattering correction was performed on the two-dimensional X-ray diffraction pattern obtained from the HyPix, and a one-dimensional SAXS profile was obtained by circular average. In this case, the horizontal axis is scattering vector q which is defined as:

q=4π sin(θ)/λ,

where λ denotes X-ray wavelength (0.154 nm), and

θ denotes scattering angle.

Igor Pro 6.37, which is a software available from WaveMetrics, was used as data analysis software. Power-law fitting was performed with the scattering intensity I in the range of 0.2<q (nm⁻¹)<0.3, and the slope B was calculated. The fitting formula is:

I=A×q^{-B}

where I denotes scattering intensity, A denotes intensity, and B denotes slope.

(2) Viscosity

After diluting the membrane-forming stock solution with N-methylpyrrolidone with 10 w/w times, the viscosity was measured using the following apparatus and conditions.
Apparatus: ARES manufactured by TA Instruments
Geometry: double cylinder type (serial number: 708.01475)
Measurement temperature: 40° C.
Shear rate: 0 to 100 (l/s)
Measurement time: 100 seconds

(3) Measurement of Inner Diameter, Outer Diameter, and Membrane Thickness

The hollow fiber membrane was cut thinly with a razor or the like in a direction perpendicular to the longitudinal direction of the membrane, and the major axis length and the minor axis length of the inner diameter of a cross section and the major axis length and the minor axis length of the outer diameter of the cross section were measured with a microscope and calculated by:

inner diameter (mm)=(inner major axis length+inner minor axis length)/2

outer diameter (mm)=(outer major axis length+outer minor axis length)/2

membrane thickness (mm)=(outer diameter−inner diameter)/2.

(4) Pure Water Permeability

A wet hollow fiber membrane having a length of about 10 cm was sealed at one end, an injection needle was placed in the hollow portion at the other end, and pure water at 25° C. was injected from the injection needle into the hollow portion at a pressure of 0.1 MPa, the amount of pure water permeating into the outer surface was measured, and the pure water permeability was calculated by the equation below. As used herein, the term “effective membrane length” refers to the net membrane length excluding the part where the injection needle is inserted.

Pure water permeability (L/m²/hr)=amount of permeated water/(π×membrane inner diameter×effective membrane length×measurement time),

where the amount of permeated water is in liters (L), the membrane inner diameter in meters (m), the effective membrane length in meters (m), and the measurement time in hours (hr).

(5) Compressive Strength

A wet hollow fiber membrane having a length of about 10 cm was sealed at one end and the other end was opened to the atmosphere. Pure water at 40° C. was pressurized from the outer surface, and permeated water was discharged from the other end opened to the atmosphere. In this case, a method of filtering the total amount of water fed to the membrane without circulation, that is, a full-volume filtration method was adopted. The pressurizing pressure was raised at intervals of 0.05 MPa from 0.1 MPa and kept at each pressure for 30 seconds, during which time the permeated water coming out from the other end opened to the atmosphere was collected. When the hollow portion of the hollow fiber membrane is not crushed, the absolute value of the amount (mass) of permeated water also increases as the pressurizing pressure increases. However, when the pressurizing pressure increases beyond the compressive strength of the hollow fiber membrane, the hollow portion collapses and clogging begins to take place. Accordingly, contrary to the increase in the pressurizing pressure, the absolute value of the amount of permeated water decreases. The pressurizing pressure at which the absolute value of the amount of permeated water is maximized was taken as the compressive strength.

(6) Dextran Rejection Rate

Dextran (product code D5376-100G, manufactured by SIGMA) having an average molecular weight of 2,000,000 was diluted with pure water to 0.1 mass % to prepare a dextran aqueous solution.

Filtration of the dextran aqueous solution was carried out as follows: the dextran aqueous solution was placed in a beaker and supplied to a wet hollow fiber having an effective length of about 10 cm with a perista pump at a flow rate of 0.1 m/s from the outer surface at an outflow pressure of 0.05 MPa, and the permeated solution was discharged from both ends (opened to the atmosphere) of the hollow fiber.

When 30 minutes passed from the start of filtration, the dextran aqueous solution and the filtrate were sampled, and the integral of the signal was measured with an RI measuring instrument (RI-8021, manufactured by Tosoh Corporation). The dextran rejection rate was calculated by:

dextran rejection rate [%]=100−(integral of the signal of the filtrate/integral of the signal of the dextran aqueous solution×100).

(7) Polyethylene Glycol Content

1H-NMR measurement of the hollow fiber membrane was carried out using d6-DMF as a solvent and tetramethylsilane as an internal standard (0 ppm) in an NMR measuring apparatus (ECS400, manufactured by JEOL Ltd.). In the obtained spectrum, from the integral (I_{PEG}) of the signal derived from polyethylene glycol appearing around 3.6 ppm, and the integral (I_{PVDF}) of the signal derived from vinylidene fluoride resin appearing around 2.3 to 2.4 ppm and 2.9 to 3.2 ppm, the polyethylene glycol content was calculated with respect to 100 wt % of the vinylidene fluoride-based resin according to the following formula:

polyethylene glycol content (wt %)={⁴⁴(I_{PEG}/4)/60(I_{PVDF}/2)}×100.

(8) Polyethylene Glycol Normalized Intensity

The hollow fiber membrane was cut with a razor in a direction perpendicular to the longitudinal direction of the membrane, and the cut surface was set as a measurement surface in the holder.

As a TOF-SIMS measurement apparatus, nanoTOF manufactured by ULVAC-PHI, Inc. was used. Before measurement, cleaning of the measurement surface was carried out as pre-treatment under the conditions of sputtering ion Ar₂₅₀₀⁺, acceleration voltage 20 kV, current 5 nA, sputtering area 1000 μm×1000 μm, and sputtering time 50 sec. Positive ions were detected under the measurement conditions of primary ion Bi₃²⁺, acceleration voltage 30 kV, current 0.1 nA (as DC), analytical area 350 μm×350 μm, and cumulative time 30 min.

In the image of the cross section of the sample, line scanning was performed in the range of about 110 μm in width from the inner surface side to the outer surface side of the membrane cross section, and the intensity of C₃F₅H₂ (m/z=133) as an ion for detection derived from vinylidene fluoride resin and the intensity of C₂H₅O (m/z=45) as an ion for detection derived from polyethylene glycol were determined, and the polyethylene glycol normalized intensity was calculated by:

polyethylene glycol normalized intensity=intensity of C₂H₅O/intensity of C₃F₅H₂.

Then, the hollow fiber membrane was divided in three equal parts by a line drawn from the inner surface side to the outer surface side of the hollow fiber membrane in the radial direction of a cross section perpendicular to the longitudinal direction of the hollow fiber membrane, and polyethylene glycol normalized intensities at respective intermediate points were determined.

(9) Fouling Resistance Test

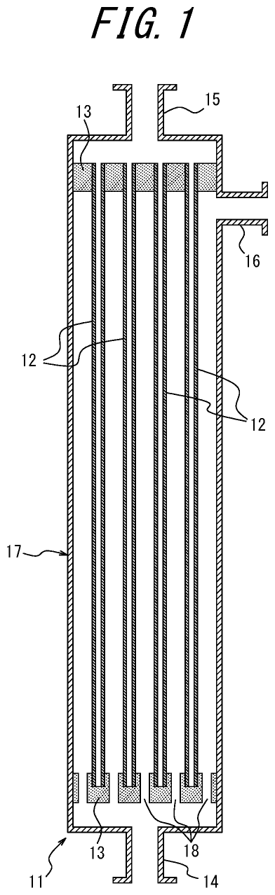

As illustrated in FIG. 1, a filtration module 11 was produced using hollow fiber membranes 12. In the filtration module 11, ten hollow fiber membranes 12 each having an effective membrane length of 10 cm are accommodated in a tubular housing 17. In the filtration module 11, each hollow fiber membrane 12 is sealed at both ends in the vicinity of the cylindrical ends of the housing 17 by an epoxy-based sealing material 13. It is noted that on one end side (the upper side in FIG. 1) of the housing 17, each hollow fiber membrane 12 passes through the epoxy-based sealing material 13, and the hollow portion is opened. It is also noted that on the other end side (the lower side in FIG. 1) of the housing 17, each hollow fiber membrane 12 terminates inside the epoxy-based sealing material 13, and the hollow portion is closed. A through hole 18 is bored in the epoxy-based sealing material 13 on the side closing the hollow portion.

The raw water enters the housing 17 from a raw water inlet 14 provided at the end of the housing 17 on the side of the epoxy-based sealing material 13 in which a through hole 18 is bored, and is filtered from the outer surface side towards the inner surface side of the hollow fiber membrane 12. The filtered water passes through the hollow portion of each hollow fiber membrane 12 and is discharged from a filtrate outlet 15 provided at the end of the housing 17 on the opposite side from the raw water inlet 14.

As the raw water, river water with TOC of 2 mg/L was used. After the filtration of the raw water for 29 min at a feeding rate of 9 mL/min, the filtered water was injected into the housing from the filtrate outlet 15 for 1 minute to backwash the hollow fiber membrane 12. At the time of backwashing, the backwash water was discharged from a backwash water outlet 16 provided between the epoxy-based sealing materials 13 on both sides and capable of discharging the fluid in the cylinder out of the cylinder. The above-described filtration and backwashing of the raw water were repeated to measure the time until the raw water injection pressure rose to 120 kPa due to clogging of the membrane.

Hereinafter, production methods according to examples and comparative examples will be described.

### Example 1

In this case, 16 wt % of polyethylene glycol having a weight-average molecular weight of 35,000 (polyethylene glycol 35000, manufactured by Merck & Co., Inc.) and, as PVDF resins, 18.7 wt % of a PVDF homopolymer (KYNAR 741, manufactured by Arkema Company) and 6.0 wt % of a PVDF homopolymer (SOLEF 6020, manufactured by Solvay Co., Ltd.) were sequentially charged to 59.3 wt % of N-methyl pyrrolidone which was temperature-controlled to 80° C., and dissolved at a stirring speed of 200 rpm to prepare a membrane-forming stock solution. It is noted that the charging of the PVDF resin was carried out after the dissolving of polyethylene glycol in N-methylpyrrolidone.

This membrane-forming stock solution was discharged as bore liquid together with a 45 wt % N-methyl pyrrolidone aqueous solution from a double-ring spinning nozzle (with an outermost diameter of 1.30 mm, an intermediate diameter of 0.50 mm, and an innermost diameter of 0.40 mm, which will be commonly used in the examples and comparative examples below), solidified in water at 83° C. after passing a free traveling distance, and then desolvated in water at 60° C. to obtain a porous hollow fiber membrane. It is noted that the free traveling distance was 170 mm, and the residence time in water at 83° C. was 16.5 seconds.

Then, the hollow fiber membrane was moistened with water at 80° C. for 3 hours and dried at 50° C. to have a moisture percentage of 1.0 wt % or less. Subsequently, the hollow fiber membrane was immersed in a 40 wt % ethanol aqueous solution to render the membrane hydrophilic. Physical properties of the membrane-forming stock solution and the hollow fiber membrane thus prepared are summarized in Table 1 including the examples and comparative examples to be descried later.

### Example 2

A membrane-forming stock solution and a hollow fiber membrane were prepared in the same manner as in Example 1 except that the stirring speed was changed to 50 rpm.

### Example 3

A membrane-forming stock solution and a hollow fiber membrane were prepared in the same manner as in Example 1 except that the stirring speed was changed to 100 rpm.

### Example 4

A membrane-forming stock solution and a hollow fiber membrane were prepared in the same manner as in Example 1 except that the PVDF resin was changed from the homopolymer to 24.7 wt % of a copolymer (KYNARFLEX 2801-00, manufactured by Arkema Company).

### Comparative Example 1

In this case, 6.0 wt % of a PVDF homopolymer (SOLEF 6020, manufactured by Solvay Co., Ltd.) and 18.7 wt % of a PVDF homopolymer (KYNAR 741, manufactured by Arkema Company) as PVDF resins, and 16 wt % of polyethylene glycol having a weight-average molecular weight of 35,000 (polyethylene glycol 35000, manufactured by Merck & Co., Inc.) were sequentially charged to 59.3 wt % of N-methyl pyrrolidone which was temperature-controlled to 80° C., and dissolved at a stirring speed of 100 rpm to prepare a membrane-forming stock solution. It is noted that the charging of polyethylene glycol was carried out after the dissolving of the PVDF resin in N-methylpyrrolidone.

Thereafter, a hollow fiber membrane was prepared in the same manner as in Example 1.

### Comparative Example 2

A membrane-forming stock solution and a hollow fiber membrane were prepared in the same manner as in Comparative Example 1 except that the drying temperature of the hollow fiber membrane was changed to 80° C.

TABLE 1

| | | | | | | | Comparative | Comparative |
|---|---|---|---|---|---|---|---|---|
| Item | | Unit | Example 1 | Example 2 | Example 3 | Example 4 | Example 1 | Example 2 |
| Hollow fiber | Outer diameter | mm | 1.35 | 1.31 | 1.34 | 1.35 | 1.34 | 1.29 |
| | Inner diameter | mm | 0.77 | 0.75 | 0.77 | 0.76 | 0.74 | 0.73 |
| | Membrane | mm | 0.29 | 0.28 | 0.29 | 0.30 | 0.30 | 0.28 |
| | thickness | | | | | | | |
| Water permeability | | L/m2/hr | 2116 | 1758 | 2092 | 2005 | 2531 | 1533 |
| Compressive strength | | MPa | 0.50 | 0.48 | 0.50 | — | 0.55 | 0.58 |
| Rejection rate | | % | 56.0 | 59.4 | 54.1 | 78.3 | 52.3 | 66.5 |
| Fouling resistance test | | min | 133 | 108 | 111 | — | 54 | 25 |
| PEG content | | wt % | 2.32 | 2.71 | 2.31 | 1.92 | 1.88 | 0.17 |
| PEG | a | — | 0.60 | 0.51 | 0.55 | 0.50 | 0.41 | 0.10 |
| normalized | b | — | 0.47 | 0.43 | 0.45 | 0.38 | 0.29 | 0.07 |
| intensity | c | — | 0.20 | 0.28 | 0.22 | 0.18 | 0.15 | 0.03 |
| Stock | Slope (B) | — | 1.19 | 1.26 | 1.20 | — | 1.11 | 1.11 |
| solution | Viscosity | Pa · s | 0.0152 | 0.0151 | 0.0150 | — | 0.0145 | 0.0145 |

### REFERENCE SIGNS LIST

11 filtration module
12 hollow fiber membrane
13 epoxy-based sealing material
14 raw water inlet
filtrate outlet
16 backwash water outlet
17 housing
18 through hole

1. A method of producing a hollow fiber membrane, comprising: extruding from a molding nozzle a membrane-forming stock solution, the membrane-forming stock solution containing a vinylidene fluoride-based resin, polyethylene glycol, and a common solvent, and having a slope (B) of 1.15 or more and less than 3.00 where the slope (B) is calculated by I=A×q^{-B} from a scattering intensity of a small-angle X-ray; and solidifying the extruded membrane-forming stock solution in a solution containing water as a main component.

2. The method of producing a hollow fiber membrane according to claim 1, wherein the membrane-forming stock solution has a viscosity of 0.0148 Pa·s or more and less than 0.0200 Pa·s at a shear rate of 50 (l/s) when diluted 10 times with a common solvent.

3. The method of producing a hollow fiber membrane according to claim 1, wherein the membrane-forming stock solution is prepared by sequentially charging the polyethylene glycol and the vinylidene fluoride-based resin to the common solvent.
